(19) United States
(12) Patent Application Publication
(10) Pub. No.: US 2022/0237516 A1
(43) Pub. Date: Jul. 28, 2022

(54) DATA MODELING SYSTEMS AND METHODS

(71) Applicant: DataRobot, Inc., Boston, MA (US)

(72) Inventors: Michael Schmidt, Cambridge, MA (US); Dylan Sherry, Somerville, MA (US); Hongmin Fan, Lexington, MA (US)

(73) Assignee: DataRobot, Inc., Boston, MA (US)

(21) Appl. No.: 17/714,835

(22) Filed: Apr. 6, 2022

Related U.S. Application Data
(63) Continuation of application No. 15/180,942, filed on Jun. 13, 2016.
(60) Provisional application No. 62/174,297, filed on Jun. 11, 2015.
(60) Provisional application No. 62/174,306, filed on Jun. 11, 2015.

(51) Int. Cl. G06N 20/00; G06N 5/02

(52) U.S. Cl. CPC G06N 20/00; G06N 5/022

(57) ABSTRACT

Data modeling systems and methods are described. A data modeling method may include receiving user input specifying a structure of at least a portion of a data model and a complexity value associated with the structure; (a) generating one or more data models; (b) determining complexity scores for the respective data models; (c) for each of the data models: determining whether to select the respective data model for evaluation based, at least in part, on the complexity score of the respective data model, and if the respective data model is selected for evaluation, evaluating an accuracy of the respective data model for one or more data sets; and repeating steps (a)-(c) until one or more specified termination criteria are satisfied, wherein a first of the generated data models includes the specified structure, and wherein the complexity score for the first data model is determined based, at least in part, on the complexity value associated with the structure.

### CROSS-REFERENCE TO RELATED APPLICATIONS

This application claims the benefit of priority under 35 U.S.C. § 120 as a continuation of U.S. patent application Ser. No. 15/180,942, filed Jun. 13, 2016, which claims the benefit of priority under 35 U.S.C. § 119(e) of U.S. Provisional Patent Application No. 62/174,297, filed on Jun. 11, 2015, and U.S. Provisional Patent Application No. 62/174,306, filed on Jun. 11, 2015, each of which is hereby incorporated by reference herein in its entirety.

### FIELD OF THE INVENTION

The present disclosure relates generally to data modeling systems and methods. Some embodiments relate specifically to determining the interpretability of data models and/or to using the interpretability of data models to guide data modeling systems and methods.

### BACKGROUND

Many data modeling (e.g., machine-learning (ML)) tools exist today that can be used to automatically generate computational models for prediction and optimization. For example, neural networks, support vector machines, decision trees, symbolic regression, and other techniques can be used to create data models (e.g., mathematical models) that can be applied to predict dependent variable values from independent variable values, based on examples (e.g., training data). These models can be used to predict values in static tables as well as in dynamic time series. Vector equations that predict multiple values simultaneously (e.g., x, y coordinates) are also available. Conventionally, users specify a query that the ML system solves, delivering a model that can be used, for example, for the predictions, regression, or classification of values.

### SUMMARY OF THE INVENTION

A major bottleneck in the use of advanced data modeling techniques and tools today is that they require a substantial technical skill level to operate. While data are becoming increasingly easy to collect, store and manipulate for lay persons, analysis tools are not keeping pace. Often the time and processing resources needed to arrive at a desired model can be significant, and in many instances overly complex models are obtained, where a simpler form may be desired.

It would be advantageous to allow users to specify one or more preferences related to the interpretability, structure, and/or other properties of data models. As a result, the model generation process may converge on a solution faster, and the result may be more interpretable (e.g., easier to understand) than were the data modeling process to be allowed to operate unconstrained.

Data models can range from a simple linear form (e.g., y=mx+b) to complex, multivariate, non-linear models (e.g., a model describing the dampening of a mass attached to a spring). Often, however, users value simplicity and speed over absolute accuracy, or, in other cases, already have a particular form of solution in mind. In some cases, as a process begins to converge on a particular form of solution, a user may recognize a particular form of model as being appropriate, or, in some cases, inappropriate.

Using some embodiments of methods and systems described herein, users can introduce one or more structural pattern preferences into a data model discovery process before and/or after the discovery process begins. The user-specified structural preferences can guide the data model discovery processes to find models that are more likely to fit the desired structural preferences. In some embodiments, the use of structural pattern preferences is applied to data model discovery process where the structure and form of the models being developed is allowed to change, such as genetic programming (GP).

According to an aspect of the present disclosure, a data-modeling method is provided, comprising: receiving user input specifying a structure of at least a portion of a data model and a complexity value associated with the structure; (a) generating one or more data models; (b) determining complexity scores for the respective data models; (c) for each of the data models: determining whether to select the respective data model for evaluation based, at least in part, on the complexity score of the respective data model, and if the respective data model is selected for evaluation, evaluating an accuracy of the respective data model for one or more data sets; and repeating steps (a)-(c) until one or more specified termination criteria are satisfied, wherein a first of the generated data models includes the specified structure, and wherein the complexity score for the first data model is determined based, at least in part, on the complexity value associated with the structure.

According to another aspect of the present disclosure, a data-modeling system is provided, comprising one or more computers programmed to perform operations comprising: receiving user input specifying a structure of at least a portion of a data model and a complexity value associated with the structure; (a) generating one or more data models; (b) determining complexity scores for the respective data models; (c) for each of the data models: determining whether to select the respective data model for evaluation based, at least in part, on the complexity score of the respective data model, and if the respective data model is selected for evaluation, evaluating an accuracy of the respective data model for one or more data sets; and repeating steps (a)-(c) until one or more specified termination criteria are satisfied, wherein a first of the generated data models includes the specified structure, and wherein the complexity score for the first data model is determined based, at least in part, on the complexity value associated with the structure.

Particular implementations of the subject matter described in the present disclosure may facilitate discovery of data models having fewer inputs in each linearly separable term, lower levels of nesting of certain classes of mathematical operators (e.g., operators that are harder to interpret and therefore undesirable when nested). As a result, the discovered models may be easier to understand and interpret than those produced without specifying structural preferences.

Conventional data modeling tools (e.g., tools that use genetic programming or other data model discovery techniques) have no implicit means of regulating the complexities of the models under consideration during a model discovery process. Some techniques (e.g., bloat control) have been proposed in the past to prevent models from becoming too complex, but these techniques do not balance the computational effort invested in different model complexities to increase overall computational performance.

It would be advantageous for data modeling tools to allocate computer resources during a data model discovery process in ways that facilitate efficient discovery of data models that are both accurate and interpretable (e.g., not overly complex). Using some embodiments of the systems and methods described herein, data modeling tools may allocate computer resources to evaluation of the accuracy of data models based, at least in part, on the interpretability of the data models. As a result, the model generation process may converge on an acceptable solution faster, and the result may be more interpretable (e.g., easier to understand) than were the data modeling process to be allowed to operate unconstrained.

According to another aspect of the present disclosure, a data modeling method is provided, comprising: (a) generating a data model; (b) determining a complexity score of the data model, wherein the complexity score is based, at least in part, on a complexity of the data model or a portion thereof; (c) probabilistically determining whether to select the data model for evaluation, wherein a probability of selecting the data model for evaluation is based, at least in part, on the complexity score of the data model; (d) if the data model is probabilistically selected for evaluation, evaluating an accuracy of the data model for one or more data sets; and repeating steps (a)-(d) for a plurality of data models until one or more specified termination criteria are satisfied.

According to another aspect of the present disclosure, a data-modeling system is provided, comprising one or more computers programmed to perform operations comprising: (a) generating a data model; (b) determining a complexity score of the data model, wherein the complexity score is based, at least in part, on a complexity of the data model or a portion thereof; (c) probabilistically determining whether to select the data model for evaluation, wherein a probability of selecting the data model for evaluation is based, at least in part, on the complexity score of the data model; (d) if the data model is probabilistically selected for evaluation, evaluating an accuracy of the data model for one or more data sets; and repeating steps (a)-(d) for a plurality of data models until one or more specified termination criteria are satisfied.

Particular implementations of the subject matter described in the present disclosure may facilitate discovery of more interpretable data models and/or more efficient allocation of computer resources during a data model discovery process.

Another limitation in the use of advanced data modeling techniques and tools today is that it can be difficult to compare the interpretability of different data models, particularly when the structures of the data models are dissimilar. Thus, there is a need for tools and techniques that facilitate comparison of data models in one or more dimensions, where one of the dimensions is interpretability.

According to another aspect of the present disclosure, a method for presenting data modeling results is provided, comprising: determining a plurality of complexity scores of a respective plurality of data models, wherein the complexity score of each data model is based, at least in part, on a complexity of the respective data model or a portion thereof; based on the complexity scores, generating a visualization of information associated with the data models; and presenting, via a user interface of a computer, the visualization of the information associated with the data models.

According to another aspect of the present disclosure, a system for presenting data modeling results is provided, comprising one or more computers programmed to perform operations comprising: determining a plurality of complexity scores ofa respective plurality of data models, wherein the complexity score of each data model is based, at least in part, on a complexity of the respective data model or a portion thereof; based on the complexity scores, generating a visualization of information associated with the data models; and presenting, via a user interface of a computer, the visualization of the information associated with the data models.

Particular implementations of the visualization techniques described in the present disclosure may facilitate comparison of data models based on their interpretability.

Other aspects and advantages of the invention will become apparent from the following drawings, detailed description, and claims, all of which illustrate the principles of the invention, by way of example only. The foregoing summary, including the description of motivations for some embodiments and/or advantages of some embodiments, is intended to assist the reader in understanding the present disclosure, and does not in any way limit the scope of any of the claims.

### BRIEF DESCRIPTION OF THE DRAWINGS

Various embodiments of the present disclosure may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1A shows a flowchart of a method for training a predictive model to determine the interpretability of data models, according to some embodiments;

FIG. 1B shows a flowchart of a method for using a predictive model to determine the interpretability of a data model, according to some embodiments;

FIG. 2A shows a flowchart of a method for using data model interpretability to guide a data modeling process, according to some embodiments;

FIG. 2B shows an example of a user interface for presenting a visualization of information associated with a data modeling process, according to some embodiments;

FIG. 3 shows a flowchart of another method for using data model interpretability to guide a data modeling process, according to some embodiments;

FIG. 4 shows an example of a user interface for presenting information associated with one or more data models, according to some embodiments; and

FIG. 5 shows a block diagram of a computer, according to some embodiments.

### DETAILED DESCRIPTION

### Terms

As used herein, a “data model” may encompass any model of relationships among data items. Some examples of data models include, without limitation, mathematical models, predictive models, stochastic models, regression models, and machine-learning models. A data model may include, for example, one or more operators, constant values, input variables, and/or output variables, which may be arranged in a particular form.

As used herein, the “interpretability” of a data model may encompass, among other things, the extent to which and/or the ease with which a data model can be interpreted to understand and/or explain aspects of systems and/or processes modeled by the data model including, without limitation, relationships among variables in data sets associated with such systems and/or processes. In some cases, the interpretability of a data model may depend, at least in part, on the data model's complexity. For example, the interpretability of a data model may increase as the data model's complexity decreases and decrease as the data model's complexity increases.

As used herein, the “complexity” of a data model refers to a characteristic of a data model that may depend on the size, degrees of freedom, and/or structure of the data model or a portion thereof, the operator(s) included in the data model, the term(s) included in the data model, data types of variable(s) included in the data model, statistical properties of variable(s) included in the data model, etc.

As used herein, the “data type” of a variable denotes the universe of values that can be assigned to the variable. In some embodiments, variables of a “Boolean data type” may be assigned one of two values (e.g., zero or one, “false” or “true”, etc.). In some embodiments, variables of a Boolean data type may be assigned a third value (e.g., “undefined”). In some embodiments, variables of a “continuous data type” may be assigned any numeric value (e.g., any complex numeric value, any real numeric value, any rational numeric value, etc.), categorical value, or class-based value. In some embodiments, variables of an “integer data type” may be assigned any integer value. In some embodiments, variables of a “real data type” may be assigned any real numeric value.

A data model may include one or more “structures” (e.g., sequences of operations). In some embodiments, two structures S1 and S2 are equivalent if the two structures consist of the same sequence of operations, even if the sequences of operations are performed on variables of different types. In some embodiments, two structures S1 and S2 are equivalent if the two structures consist of the same sequence of operations performed on variables of the same type.

Two data models M1 and M2 may have “substantially the same” interpretability or “substantially similar” interpretability if their complexity scores are equal, are within the same specified range, or if the percentage difference between their complexity scores is less than or equal to a specified percentage (e.g., 10%).

As used herein, a “data modeling tool” is a device or system (e.g., one or more computers executing a program) that is operable to perform a data modeling process (e.g., a model discovery process).

### 1.0 Exemplary Techniques for Determining the Interpretability of a Data Model

In some embodiments, the interpretability of a data model depends on a complexity score for the data model. A data model's complexity score may be determined, for example, by applying a scoring function or a predictive model to attribute data indicative of attributes of the data model, or by using any other suitable technique. Some examples of scoring functions and predictive models suitable for determining a data model's complexity score are described below.

### 1.1 Exemplary Scoring Functions for Determining Complexity Scores

In some embodiments, a scoring function is used to calculate a complexity score CS(M) for a data model M based, at least in part, on the complexity of the data model as a whole and/or on the complexities of individual terms (e.g., linearly separable terms) of the data model. Some examples of techniques for calculating a complexity score CS₁(M) for a data model M based on the complexity of the data model as a whole, as well as some examples of techniques for calculating a complexity score CS₂(M) for a data model based on the complexities of individual terms of the data model, are described below.

A complexity score CS(M) for a data model M may be determined based on the complexity scores CS₁(M) and CS₂(M) for the data model. For example, the complexity score CS(M) may be equal to the greater of CS₁(M) and CS₂(M), the lesser of CS₁(M) and CS₂(M), the sum of CS₁(M) and CS₂(M), a weighted sum of CS₁(M) and CS₂(M), etc.

In some embodiments, a data model M may be transformed into a standard form M_{S}, and a complexity score (e.g., CS, CS₁, CS₂, etc.) for the data model M may be calculated by applying scoring techniques described herein to the transformed data model M_{S} and/or portions thereof. Transforming data models into a standard form before calculating the data models' complexity scores may facilitate comparisons of the interpretability and complexity of different data models.

### 1.1.1 Exemplary Scoring Functions Based on the Complexity of a Data Model as a Whole

In some embodiments, a data model's complexity score depends, at least in part, on the complexity of the data model as a whole. A scoring function may be used to calculate a complexity score CS₁(M) for a data model M based on the complexity of the data model as a whole. In some embodiments, the complexity score CS₁(M) for a data model depends, at least in part, on the operators that appear in the data model M, the number of occurrences of each operator in the data model, the input variables that appear in the data model, and/or the number of occurrences of each input variable in the data model. In addition or in the alternative, the complexity score CS₁(M) for a data model may depend on other attributes of the data model or the data represented by the data model. For example, the complexity score CS₁(M) for a data model may depend on the number of constant values that occur in the data model.

In some embodiments, the complexity score CS₁(M) for a data model M may be calculated using the following scoring function (“SF1”):

$$C {S}_{1} ( M ) = {\sum }_{{all}_{operators F ∈ M}} ( C V ( F ) * count ( F ) ) + {\sum }_{{all input}_{variables N ∈ M}} ( C V ( N ) * count ( N ) )$$

where CV(F) is a complexity value associated with operator F, count(F) is the number of occurrences of operator F in the data model M, CV(N) is a complexity value associated with an input variable N of the data model, and count(N) is the number of occurrences of the input variable N in the data model M. For reasons that will be apparent to one of ordinary skill in the art, the complexity score CS₁ of a data model as calculated using scoring function SF1 may be referred to herein as the “parse tree complexity” or “tree complexity” of the data model. Scoring function SF1 is just one example of a scoring function suitable for calculating the complexity score CS₁(M) for a data model M based on the complexity of the data model as a whole. The complexity score CS₁(M) for a data model M may be calculated using other suitable scoring functions.

The complexity value of an operator F may be specified by a user (e.g., an expert), determined using a machine-learning tool, or determined using any other suitable technique. In some embodiments, a computer or program may provide a default complexity value for an operator F in cases where a user has not specified a complexity value for the operator. For example, default complexity values may be provided for operators as shown in Table 1.

TABLE 1

| | Complexity |
|---|---|
| Operator | Value |
| Addition (+), subtraction (−), or | 0 |
| multiplication (*) | |
| Division (/) | 2 |
| Natural logarithm (ln), logarithm (log) | 2 |
| Conditional (if-then, if-then-else) | 1 |
| Logistic function | 4 |
| Step function | 2 |
| Minimum (min) or maximum (max) | 1 |
| Relational {less than (<), greater than (>), less | 1 |
| than or equal to (≤), greater than or equal to (≥), | |
| equal to (==), or not equal to (=/=)} | |
| Square root | 1 |

In general, a higher complexity value for an operator may indicate that the presence of the operator in a data model tends to have a more detrimental effect on the interpretability of a data model. In some embodiments, user-provided complexity values for operators and/or default values for operators may be domain-specific (e.g., application-specific, industry-specific, etc.), because the same operator may have different effects on the interpretability of data models in different domains.

The complexity value of an input variable may depend on attributes of the input variable, for example, the variable's data type, the variable's statistical properties, etc. For example, the complexity value of an input variable may be equal to the sum of a complexity value associated with the variable's data type and a complexity value associated with the variable's statistical properties. The complexity value of an input variable may be calculated using other suitable techniques.

The complexity value corresponding to the data type of an input variable may be specified by a user or a machine-learning tool, provided by a computer or program (e.g., as a default complexity value), or obtained using any other suitable technique. In some embodiments, the default complexity value is zero (0) for variables of the Boolean data type. In some embodiments, the default complexity value is two (2) for variables of a continuous data type. In some embodiments, the default complexity value is one (1) for variables of the integer data type and two (2) for variables of the real data type.

The complexity value corresponding to the statistical properties of an input variable may be calculated based on individual complexity values corresponding to individual statistical properties of the input variable. For example, the complexity value corresponding to the statistical properties of an input variable may be equal to the sum of the individual complexity values associated with the variable's individual statistical properties.

The complexity values corresponding to individual statistical properties of an input variable of a data model may be specified by a user or a machine-learning tool, provided by a computer or program (e.g., as default complexity values), or obtained using any other suitable technique. The individual statistical properties of an input variable may be determined based on a statistical analysis of values of the input variable contained in the records of one or more data sets represented by the data model.

Some examples of individual statistical properties of input variables include the “missing value” property, the “outlier” property, and any other suitable property. An input variable may exhibit the “missing value” property if the number or percentage of records in which the value of the input variable is undefined (“missing”) exceeds a threshold number of records (e.g., zero records) or percentage of records (e.g., 1% of records). An input variable may exhibit the “outlier” property if the number or percentage of records in which the input variable's value is an outlier exceeds a threshold number of records (e.g., zero records) or percentage of records (e.g., 0.5% of records). Any suitable technique may be used to determine whether a particular value of an input variable is an outlier. Other examples of individual statistical properties of an input variable may include its covariance with one or more other input variables, its rank correlation with one or more other input variables, its heteroscedasticity, its stationarity, its variance (e.g., the extent to which the variable has constant or varying values), whether the variable is monotonic or correlated with row or time, the uniqueness of the variable's name, etc. Any suitable technique may be used to determine whether an input variable exhibits a particular individual statistical property, or the extent to which an input variable exhibits a particular statistical property.

### 1.1.2 Exemplary Scoring Functions for Terms of Data Models

In some embodiments, a data model's complexity score depends, at least in part, on the complexities of individual terms (e.g., linearly separable terms) of the data model. A scoring function may be used to calculate a complexity score CS₂(M) for a data model M based on complexity scores CS_{TERM}(T) for individual terms T of the data model. For example, the complexity score CS₂(M) for a data model M may be equal to the greatest complexity score CS_{TERM}(T) of any term of the data model M, the sum of the complexity scores of the terms T of the data model M, a weighted sum of the complexity scores of the terms T of the data model M, etc.

In some embodiments, the complexity score CS_{TERM}(T) for an individual term of a data model M depends, at least in part, on a complexity sub-score CS_{NEST}(T) associated with nesting of operators in the term T, a complexity sub-score CS_{NUM_VARS}(T) associated with the number of variables in the term T, a complexity sub-score CS_{TYPE_VARS}(T) associated with the data types of variables in the term T, a complexity sub-score CS_{STAT_VARS}(T) associated with the statistical properties of variables in the term T, and/or a complexity sub-score CS_{STRUCT}(T) associated with the presence of one or more specified structures in the term T. Other complexity sub-scores for terms T of a data model M are possible. For example, the complexity score CS_{TERM}(T) for an individual term of a data model M may depend on a complexity sub-score CS_{CONST}(T) associated with the number of constant values in the term T.

A scoring function may be used to calculate a complexity score CS_{TERM}(T) for a term T of a data model based on one or more complexity sub-scores CS_{NEST}(T), CS_{NUM_VARS}(T), CS_{TYPE_VARS}(T), CS_{STAT_VARS}(T), CS_{STRUCT}(T), etc. for the term T. For example, the complexity score CS_{TERM}(T) for a term T may be equal to the greatest complexity sub-score for the term T, the sum of one or more of the complexity sub-scores for the term T, a weighted sum of one or more of the complexity sub-scores for the term T, etc.

The complexity sub-score CS_{NEST}(T) associated with nesting of operators in the term T may depend, at least in part, on a level L of nesting (e.g., maximum level of nesting) of operators in the term T and on a complexity value CV_{NEST} associated with operator nesting. For example, CS_{NEST}(T) may be equal to the product of L and CV_{NEST}. Alternatively, the complexity value CV_{NEST} may be specified as a function of the nesting level L, and the complexity sub-score CS_{NEST}(T) may be equal to the value of CV_{NEST} corresponding to the nesting level L. The level of nesting of operators in a term T can be determined using any suitable technique. In some embodiments, nesting level L of a term T is assessed only with respect to particular types of operators (e.g., exponential operators, sigmoid functions, logistic functions, and/or squashing functions). The complexity value CV_{NEST} may be specified by a user or a machine-learning tool, or a default value may be provided by a computer or program.

The complexity sub-score CS_{NUM_VARS}(T) associated with the number of variables in the term T may depend, at least in part, on the number of variables NV in the term T and a complexity value CV_{NUM_VARS} associated with the number of variables. For example, CS_{NUM_VARS}(T) may be equal to the product of NV and CV_{NUM_VARS}. Alternatively, the complexity value CV_{NUM_VARS} may be specified as a function of the number of variables NV, and the complexity sub-score CS_{NUM_VARS}(T) may be equal to the value of CV_{NUM_VARS} corresponding to the number of variables NV. The complexity value CV_{NUM_VARS} may be specified by a user or a machine-learning tool, or a default value may be provided by a computer or program. In some embodiments, the number of variables NV represents the number of unique variables in the term T. In some embodiments, the number of variables NV represents the number of occurrences of all variables in the term T, including multiple occurrences of the same variable.

The complexity sub-score CS_{TYPE_VARS}(T) associated with the data types of variables in the term T may depend, at least in part, on complexity values CV of the data types of the variables included in term T. For example, CS_{TYPE_VARS}(T) may be equal to

max(CV(data_type(Vj))) for j=1 . . . NV, or

sum(CV(data_type(Vj))) for j=1 . . . NV,

where NV is the number of variables in the term T, Vj is the jth variable in term T, data_type(V) is the data type of variable V, CV(data_type) is the complexity value of the specified data type, “max(CV₁, . . . CV_{NV})” is the maximum complexity value in a sequence of complexity values (CV₁, . . . , CV_{NV}), and “sum(CV₁, . . . CV_{NV})” is the sum of a sequence of complexity values (CV₁, . . . , CV_{NV}). The complexity values of the data types may be specified by a user or a machine-learning tool, or default values may be provided by a computer or program. Other scoring functions for determining the complexity sub-score CS_{TYPE_VARS}(T) are possible.

The complexity sub-score CS_{STAT_VARS}(T) associated with the statistical properties of variables in the term T may depend, at least in part, on individual complexity values CV associated with the statistical properties of individual variables in the term T. For example, CS_{STAT_VARS}(T) may be equal to

max(cv_stat_prop(Vj)) for j=1 . . . NV, or

sum(cv_stat_prop(Vj)) for j=1 . . . NV,

where NV is the number of variables in the term T, Vj is the jth variable in term T, cv_stat_prop(V) is the complexity value corresponding to the statistical properties of variable V, “max(CV₁, . . . CV_{N})” is the maximum complexity value in a sequence of complexity values (CV₁, . . . , CV_{NV}), and “sum(CV₁, . . . CV_{NV})” is the sum of a sequence of complexity values (CV₁, . . . , CV_{NV}). Some techniques for determining the complexity value corresponding to the statistical properties of an input variable V are described above in Section 1.1.1. Other scoring functions for determining the complexity sub-score CS_{STAT_VARS}(T) are possible.

In some embodiments, the set of complexity scores CS_{TERM}(T) for individual terms T of the data model includes a complexity score CS_{TERM}(T_{OUT}) for an output term T_{OUT} of the data model. The output term T_{OUT} may include one or more output variables V_{OUT}. For purposes of calculating the complexity sub-score CS_{STAT_VARS}(T_{OUT}) associated with the statistical properties of variables in the term T_{OUT}, some examples of individual statistical properties for output variables include the “independence of residual errors” property, the “smoothness” property, the “heteroscedasticity” property, and any other suitable property. In some embodiments, the complexity value corresponding to the statistical properties of an output variable V_{OUT} generally increases as the independence of residuals, the smoothness, and the heteroscedasticity of the output variable decrease. Other examples of individual statistical properties of an output variable may include uneven variance (e.g., Levene's statistic and/or similar statistics), outliers (e.g., large missed predictions), autocorrelation of residuals, non-zero mean value, non-normal distribution (e.g., kurtosis statistic), covariance with independent variables, etc. Any suitable technique may be used to determine whether (or the extent to which) an output variable exhibits a particular individual statistical property.

The complexity sub-score CS_{STRUCT}(T) associated with the presence of one or more specified structures in the term T may depend, at least in part, on complexity values CV of the structures S included in term T. For example, CS_{STRUCT}(T) may be equal to

max(CV(Sj)) for j=1 . . . NS, or

sum(CV(Sj)) for j=1 . . . NS,

where NS is the number of structures in the term T, Sj is the jth structure in term T, CV(S) is the complexity value of the specified structure S, “max(CV₁, . . . CV_{NS})” is the maximum complexity value in a sequence of complexity values (CV₁, . . . , CV_{NS}), and “sum(CV₁, . . . CV_{NS})” is the sum of a sequence of complexity values (CV₁, . . . , CV_{NS}). The complexity values of the structures may be specified by a user or a machine-learning tool, or default values may be provided by a computer or program. In some embodiments, user input representing a particular structure may include a regular expression representing the particular structure and/or a string representing the particular structure in a formal grammar. Other scoring functions for determining the complexity sub-score CS_{STRUCT}(T) are possible.

### 1.1.3 An Exemplary Complexity Scoring Function for Data Models

In some embodiments, a complexity score CS(M) for a data model M may be determined using the following scoring function (“SF2”):

$$C S ( M ) = T C W * C {S}_{1} ( M ) + {\sum }_{all terms T ∈ M} C {S}_{TERM} ( T )$$

where CS₁(M) is the tree complexity of the data model M, TCW is a weight associated with the tree complexity, and CS_{TERM}(T) is determined using the following scoring function (“SF3”):

| | |
|---|---|
| CS_{TERM}(T) = | if (nConVars(T) > 0): |
| | nBoolVars(T) * CV_BoolVars + (nConVars(T) − 1) * |
| | CV_ConVars |
| | else if (nBoolVars(T) > 0): |
| | (nBoolVars(T) − 1) * CV_BoolVars |
| | else: 0 |
| | + |
| | if (nestLevel(T) > 0): |
| | (nestLevel(T) − 1) * CV_Nesting |
| | else: 0 |

where nConVars(T) is the number of continuous variables in the term T, nBoolVars(T) is the number of Boolean variables in the term T, CV_BoolVars is a complexity value associated with Boolean variables, CV_ConVars is a complexity value associated with continuous variables, nestLevel(T) is a nesting level (e.g., maximum nesting level) of operators in term T, and CV_Nesting is a complexity value associated with operator nesting. In some embodiments, the default values of TCW, CV_BoolVars, CV_ConVars, and CV_Nesting are 1, 1, 10, and 10, respectively. The user may provide alternative complexity values.

### 1.2 Exemplary Predictive Models for Determining Complexity Scores

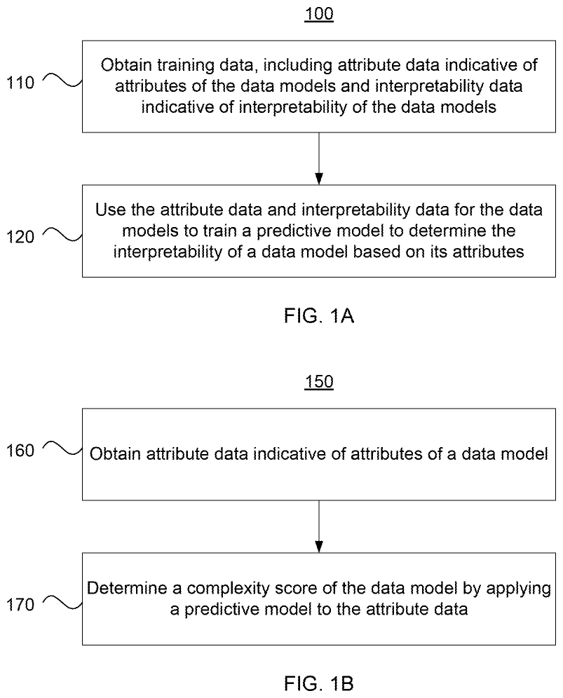

In some embodiments, a predictive model is used to determine a data model's complexity score (e.g., based on attribute data describing attributes of the data model). The predictive model may be a regression model, a machine-learning model, or any other suitable type of predictive model. The predictive model may be trained using any suitable technique, including, without limitation, the training method 100 illustrated in FIG. 1A.

FIG. 1A illustrates a method 100 for training a predictive model to determine the interpretability of a data model, according to some embodiments. The training method 100 includes a step 110 of obtaining training data, including attribute data describing attributes of a set of data models and interpretability data characterizing the interpretability of those data models. The training method 100 also includes a step 120 of using the training data to train a predictive model to determine the interpretability of data models based on the data models' attributes. Some embodiments of the training method 100 are described in further detail below.

In step 110, attribute data describing attributes of data models are obtained. The data models used to train the predictive model may be obtained from textbooks, from data modeling tools, or from any other suitable source. The attribute data for each data model may be provided by users or extracted by analyzing the data model using any other suitable technique. The attribute data for a data model may identify a level of operator nesting in the data model or in portions thereof (e.g., a level of nesting in each term of the data model), one or more operators included in the data model, one or more structures included in the data model (e.g., specific structures identified by the user as being either favorable or unfavorable), properties of one or more input and/or output variables included in the data model (e.g., number of variables, data types of variables, statistical properties of variables, etc.), an amount of computational effort needed to find and fit the model, an amount of computational effort needed to evaluate the model, and/or any other suitable attributes of the data model.

In step 110, interpretability data characterizing the interpretability of the data models are also obtained. The interpretability data may be provided by users (e.g., experts) or obtained using any other suitable technique. The interpretability data for a data model M may include a complexity score CS(M) for the data model M, a complexity score CS₁(M) calculated based on the complexity of the data model as a whole, a complexity score CS₂(M) calculated based on the complexities of individual terms of the data model, and/or any other suitable data characterizing the interpretability of the data model or any portion thereof.

In step 120, the training data obtained in step 110 are used to train the predictive model to determine the interpretability of data models based on their attributes. Any suitable technique may be used to train the predictive model. In some embodiments, the predictive model is trained by fitting the predictive model to the training data. In some embodiments, complexity scores of data models are used as the targets (or “responses”) for the predictive model, and attribute data of the data models are used as the features (or “predictors”) for the predictive model.

FIG. 1B illustrates a method 150 for using a predictive model to determine the interpretability of a data model, according to some embodiments. The predictive method 150 includes a step 160 of obtaining attribute data for a data model. Some examples of attribute data and techniques for obtaining attribute data are described above. The predictive method 150 also includes a step 170 of applying the predictive model to the data model's attribute data to determine the interpretability of the data model or a portion thereof. Determining the interpretability of the data model M may include estimating a complexity score CS(M) of the data model M, a complexity score CS₁(M) characterizing the complexity of the data model as a whole, a complexity score CS₂(M) characterizing the complexities of individual terms of the data model, and/or any other score characterizing the interpretability and/or complexity of the data model or any portion thereof.

Some embodiments have been described in which a predictive model is trained and used to determine the interpretability of a data model or a portion thereof. In some embodiments, a predictive model may be trained and used to tune the complexity values or other parameters of a scoring function (for example, any of the scoring functions described herein).

In some embodiments, the data modeling tool measures and quantifies the interpretability of a data model based on characteristics of the model's parse tree size, the types of operations the data model contains, and/or the manner in which different types of mathematical variables, factors, and terms appear in the data model. The interpretability of a particular model may be configured or customized by manipulating real-valued penalty values corresponding to various properties of data models.

### 2.0 Exemplary Techniques for Discovering Interpretable Data Models

Data modeling tools may be used to discover data models that have various degrees of interpretability and accuracy. Section 2.1 describes some embodiments of a method 200 for using data model interpretability to guide allocation (e.g., to probabilistically guide allocation) of resources (e.g., computational resources) during a data model discovery process. Performing the method 200 may result in efficient discovery of data models that are both accurate and interpretable. Section 2.2 describes some embodiments of a method 300 for using data model interpretability to guide a data modeling process to find data models that are more likely to conform to specified preferences (e.g., preferences relating to the interpretability, structure, or other properties of the data models).

### 2.1 Exemplary Techniques for Probabilistic Model Discovery Based on Model Interpretability

In some embodiments, a data modeling tool may allocate resources (e.g., computational resources) to evaluation of the accuracy of data models based, at least in part, on the interpretability of the data models. For example, a data modeling tool may obtain (e.g., produce) a population of candidate data models and select a subset of those models for evaluation, discarding the others. The tool may select the subset of models based, at least in part, on their interpretability. For example, the tool may select models for evaluation such that the complexity scores for the selected subset of models conform to a specified distribution, fall within a specified range, conform to a specified distribution within a specified range, etc. This complexity balancing process may occur during each iteration of a data model discovery process, less frequently, or as requested by a user. In some embodiments, the complexity balancing process may be scheduled to occur asynchronously with respect to the iterations of the model discovery process.

More specifically, a target model population size may be determined, or, in some cases, provided by a user. The data modeling tool may iterate while the total number of candidate models is less than the specified target population size. New models may be generated, and for each new model a complexity score S characterizing the complexity of the model may be calculated. If the complexity score S falls within a specified (e.g., optimal) range, the model may be selected for evaluation (e.g., for evaluation of the model's accuracy). If the complexity score S falls outside the specified range, the model may be discarded. Each of the selected models may be evaluated for accuracy. This process of generating new models, selecting a subset of the new models based on their complexity scores, and evaluating the selected models for accuracy may be repeated until one or more specified termination criteria are reached. Some examples of termination criteria include identifying a model with accuracy in excess of a threshold, identifying a model with a complexity score within a specified range, identifying a model with a specified combination of accuracy and interpretability, etc.

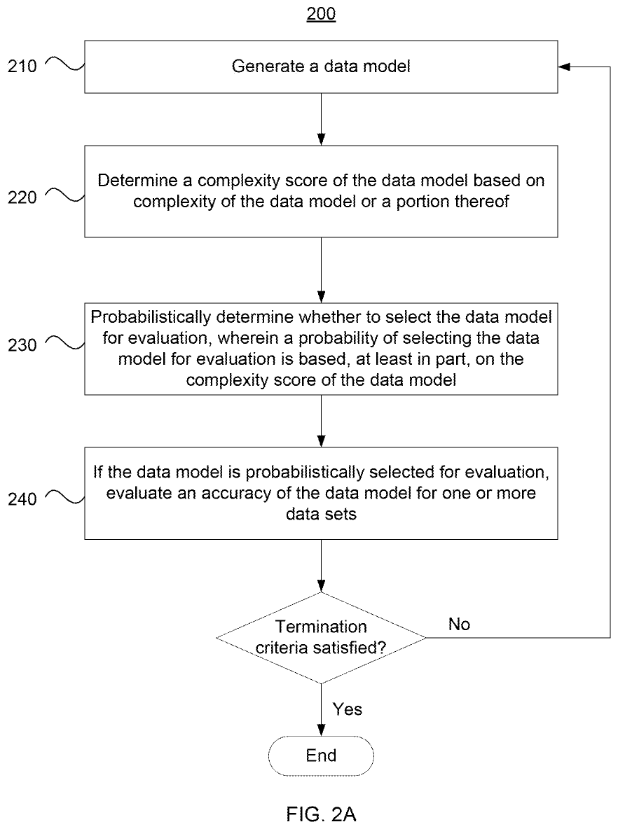

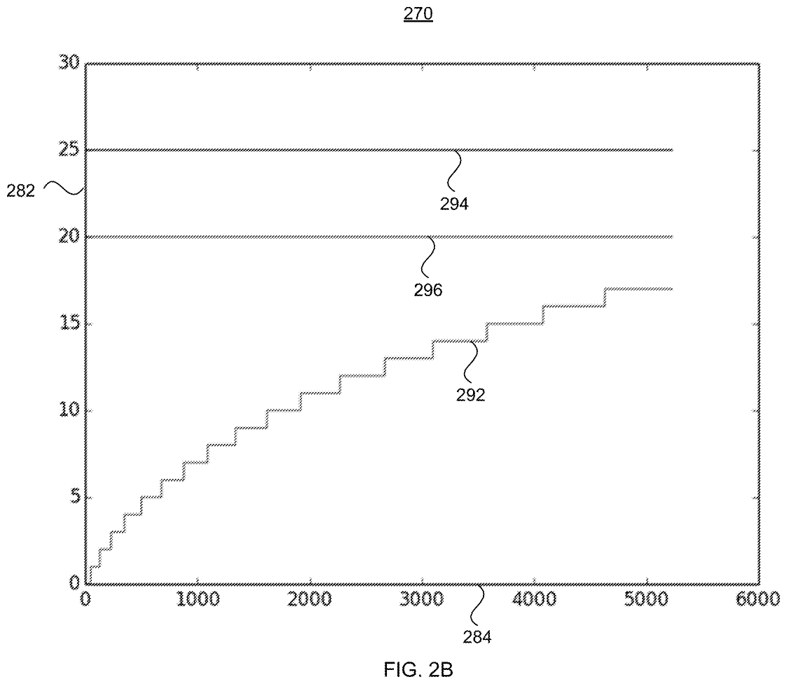

FIG. 2A illustrates a method 200 for using data model interpretability to guide a data modeling process, according to some embodiments. By performing the data modeling method 200, a data modeling tool may allocate resources (e.g., computational resources) to evaluation of data models based, at least in part, on the interpretability of the data models. In the example of FIG. 2A, the data modeling method 200 includes a step 210 of generating a data model, a step 220 of determining the complexity score of the data model based, at least in part, on the complexity of the data model or a portion thereof, and a step 230 of probabilistically determining whether to select the data model for evaluation. The probability of selecting the data model for evaluation is based, at least in part, on the complexity score of the data model. The data modeling method 200 further includes a step 240 in which the data model is evaluated (e.g., for accuracy) if the data model has been probabilistically selected for evaluation. The steps 210-240 may be executed iteratively until one or more termination criteria are satisfied. Some embodiments of the data modeling method 200 are described in further detail below.

In step 210, the data modeling tool generates a data model. Any suitable technique for generating the data model may be used.

In step 220, the data modeling tool determines a complexity score of the generated data model. The complexity score is based, at least in part, on the complexity of the data model or a portion thereof. Any suitable technique for determining the complexity score of a data model may be used, including the techniques described in Sections 1.0-1.2.

In step 230, the data modeling tool probabilistically determines whether to select the data model for evaluation. The probability of selecting the data model for evaluation is based, at least in part, on the complexity score of the data model. By controlling the probability of selecting a data model for evaluation based on the data model's complexity score, the data modeling tool can allocate resources (e.g., computational resources) to the evaluation of data models based on their interpretability, which can lead the data model discovery process to efficiently converge on a data model with acceptable accuracy and interpretability. For example, a range of complexity scores [S1, S2] may be selected (e.g., by the data modeling tool, by a user, etc.), and a first probability value PV1 may be assigned to complexity scores within the range, whereas a second probability value PV2 may be assigned to complexity scores outside the range. The data modeling tool may use the probability value PV1 as the probability of selecting a data model M with a complexity score S within the range [S1, S2] for evaluation, and may use the probability value PV2 as the probability of selecting a data model M with a complexity score S outside the range [S1, S2] for evaluation. In this way, the data modeling tool can allocate different amounts of computational effort to different regions of the model space along the interpretability dimension. In some embodiments, PV1 may be 100% and PV2 may be 0%, such that only data models having complexity scores within the range [S1, S2] are selected for evaluation. In some embodiments, PV1 may be 100% and PV2 may be 50%.

In some embodiments, the probability of selecting a data model M for evaluation is further based, at least in part, on an amount of computational effort already expended for evaluation of data models having the same complexity score as the data model M or complexity scores within a same specified range as the complexity score of the data model M. For example, probability values PV(S) may be assigned to corresponding complexity scores S, such that the probability value assigned to a complexity score (or range of scores) depends on the computational effort already expended for evaluation of data models having that complexity score (or range of scores). In some embodiments, the probability value PV(S) assigned to a complexity score S may vary inversely with the amount of computational resources already expended for evaluation of data models having the complexity score S. The data modeling tool may use the probability value PV(S) as the probability of selecting a data model M with a complexity score S for evaluation. In this way, the data models M selected for evaluation may represent a fairly uniform sample of the data models along the interpretability dimension of the model space.

In some embodiments, the probability of selecting a data model M for evaluation is further based, at least in part, on an amount of computational effort budgeted for evaluation of data models having the same complexity score as the data model M or complexity scores within a same specified range as the complexity score of the data model M. Computational effort may be budgeted (e.g., by a user, by the data modeling tool, etc.) for evaluation of data models by assigning a probability distribution PD(S) to the range of complexity scores S, such that the probability value assigned to a complexity score (or range of scores) depends on the amount (or proportion) of computational effort budgeted for evaluation of data models having the complexity score S. The data modeling tool may use the probability value PD(S) as the probability of selecting a data model M with a complexity score S for evaluation. In this way, the probability of selecting a data model M with complexity score S for evaluation may be proportional to the amount of computational resources budgeted for evaluation of data models having complexity score S.

In some embodiments, the probability of selecting the data model for evaluation is further based, at least in part, on one or more user-provided heuristics for allocation of computational effort to evaluation of data models based on respective complexity scores thereof.

In some embodiments, the probability of selecting the data model for evaluation is further based, at least in part, on an allocation policy provided by a machine learning model, wherein the allocation policy specifies an allocation of computational effort to evaluation of data models based on respective complexity scores thereof. In some embodiments, the allocation policy is generated using a machine model trained to allocate computational resources for the evaluation of data models based on the amount of computational effort already expended on the evaluation of data models with various complexity scores and the accuracies of such data models. For example, the machine model may be trained using training data extracted from one or more prior data model discovery processes. The training data may indicate the complexity scores and accuracies of the data models evaluated during the model discovery process(es), and the amount of computational resources expended to evaluate such data models.

In some embodiments, the probability of selecting a data model M1 for evaluation is further based, at least in part, on the amount of time elapsed and/or the amount of computational effort expended since evaluating a data model M2 that (1) has substantially the same interpretability as data model M1, and (2) has the greatest accuracy of any evaluated data model having substantially the same interpretability as data model M1.

In some embodiments, the spectrum of complexity scores may be segmented into two or more ranges, and a probability value may be assigned to each range of complexity scores and used by the data modeling tool as the probability of selecting a data model M within a complexity score within the specified range for evaluation. In the extreme, a probability value may be assigned to each individual complexity score along the spectrum of complexity scores.

FIG. 2B shows an example of a user interface for presenting a visualization 270 of a data modeling process in which data models having complexity scores within a dynamically adjustable range [S1, S2] are selected for evaluation with a first probability P1, and data models having complexity scores outside that range are selected for evaluation with a second probability P2. In some embodiments, the first probability P1 is 100% and the second probability P2 is 50%, such that the data model discovery process focuses on evaluation of models with complexity scores within the adjustable range, but still evaluates some models having complexity scores outside that range.

In the visualization 270 of FIG. 2B, the x-axis 284 represents iterations of a data model discovery process (e.g., generations of an evolutionary data model search process), and the y-axis 282 represents a range of complexity scores for data models. The curves 292 and 294 represent the lower and the upper limits, respectively, of the adjustable range. In the example of FIG. 2B, the lower limit S1 increases as the number of iterations increases, and the upper limit S2 remains constant. In some embodiments, the upper limit S2 also varies (e.g., decreases) as the number of iterations increases.

In some embodiments, the visualization 270 includes a curve 296 representing a maximum value of the lower limit S1 of the range of complexity scores. If the lower limit S1 reaches the maximum value represented by the curve 296 before the model discovery process terminates, the data modeling tool may reset the lower limit S1 to a lower value (e.g., zero). In some embodiments, the curve 296 represents a target complexity score, which the lower limit S1 and the upper limit S2 approach as the number of iterations of the discovery process increase.

In some embodiments, the rate at which the value of the lower limit S2 increases (e.g., approaches the maximum value 296 of the lower limit S2) is determined as follows. The data modeling tool may keep track of the last iteration ITER_BETTER in which the tool discovered a better (e.g., more accurate) model M with a complexity score equal to the current value of the lower limit S2. If the current iteration ITER_CUR is X times greater than ITER_BETTER and Y iterations greater than ITER_BETTER, the data modeling tool may increase the value of the lower limit S2 by a specified value (e.g., one). The values of X and Y may be provided by the user, or the data modeling tool may provide default values. In this way, the data modeling tool continues to use computational resources to search for more accurate data models having a particular degree of interpretability until the results of the discovery process suggest that the most accurate model having that degree of interpretability has already been discovered.

Returning to FIG. 2A, in step 240, if the data model M has been probabilistically selected for evaluation, the data modeling tool evaluates the data model M (e.g., evaluates the accuracy of the data model M for one or more data sets).

The data modeling tool may terminate the model discovery process when any suitable termination criteria are met. Some examples of suitable termination criteria include (1) an amount of computational effort budgeted for the discovery process has been expended, (2) an amount of time allotted for the discovery process has elapsed, (3) a data model M having a complexity score less than or equal to a specified threshold and an accuracy greater than or equal to a specified threshold has been discovered, (4) any suitable combination of the foregoing criteria, etc.

Some examples have been described in which a data model discovery process is controlled based, at least in part, on an amount of computational effort expended. Any suitable metric for computational effort may be used, including, without limitation, number of data models evaluated, amount of wall clock time elapsed, amount of processor time elapsed, amount of power or energy consumed by the computation, number of model updates, number of iterations (e.g., generations, epochs, etc.) of the discovery process, etc. Computational effort may be measured and allocated with respect to a single processing core or device, multiple processing cores or devices, a network of computers, etc.

Some examples have been described in which candidate data models are either selected for evaluation or discarded based, at least in part, on their interpretability. The decision to evaluate or discard a data model is, in effect, a decision to allocate or not allocate computational resources to analysis of the data model. In some embodiments, a data modeling tool may allocate computational resources to analysis of a data model not only by selecting the data model for evaluation, but also by assigning specific computational resources to the evaluation of specific data models. For example, the data modeling tool may allocate a specific set of processing cores or devices for analysis of data models having complexity scores within a first range, and may allocate a different set (e.g., a smaller set) of processing cores or devices for analysis of data models having complexity scores within a second range.

Some examples have been described in which computational resources are allocated or not allocated to analysis of a data model by probabilistically selecting or discarding the data model. In some embodiments, different amounts of computational resources are allocated for the analysis of data models of different complexity. For example, a particular set of processing devices or a particular amount of processor time may be allocated for analysis of data models having complexity scores within a first range, and a different (e.g., smaller) set of processing devices or a different (e.g., smaller) amount of processor time may be allocated for analysis of data models having complexity scores within a second range. In some embodiments, the data modeling tool may use a machine learning model to allocate computational resources to evaluation of data models of different complexities.

Some examples have been described in which a data modeling tool uses a probability value PV to probabilistically select a data model M with a complexity score S for evaluation. Probabilistic selection may be implemented as follows. In some embodiments, the probability value PV is represented as a number between 0.0 and 1.0, and the data modeling tool generates a random number R between 0.0 and 1.0 for the data model M. If R is less than or equal to PV, the data model M is probabilistically selected for evaluation. Otherwise, the data model M is not selected. Other probabilistic selection techniques are possible.

Some examples have been described in which a data modeling tool generates data models, determines the interpretability of the data models, selects a subset of the data models based on their interpretability, evaluates the selected models, and discards the other models. In some embodiments, the process of generating data models may be parameterized to favor (e.g., to probabilistically favor) generation of data models having complexity scores within a specified range.

Conceptually, performing some embodiments of the data modeling method 100 may cause the data modeling tool to adapt the computational effort invested in the analysis of data models exhibiting different degrees of interpretability based on the progress and statistics of the data model discovery process, and based on the properties of the data models already discovered.

Conceptually, performing some embodiments of the data modeling method 100 may cause the data modeling tool to focus computational resources on analysis of data models exhibiting a degree of interpretability for which a better (e.g., more accurate) data model than the data models discovered thus far is likely to be discovered. In other words, the data modeling tool may focus computational resources on discovery of a more accurate data model with a specified degree of interpretability, if the results of the discovery process thus far indicate that such a data model is likely to exist.

### 2.2 Exemplary Techniques for Model Discovery Based on Interpretability and Preferences

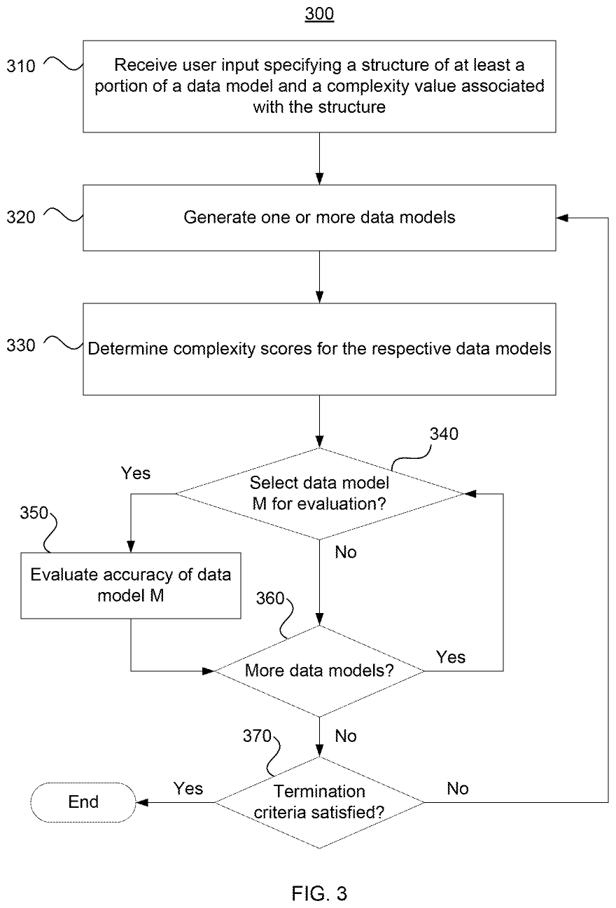

FIG. 3 shows a flowchart of a method 300 for using data model interpretability to guide a model discovery process to discover data models that are more likely to conform to specified preferences (e.g., preferences relating to interpretability, structure, and/or other properties of the data models). Using the data modeling method 300, users can introduce one or more preferences into a data model discovery process before and/or after the discovery process begins. The user-specified preferences can guide the data model discovery processes to find models that are more likely to conform to the desired preferences. In some embodiments, at least one of the specified preferences relates to data model structure.

In the example of FIG. 3, the data modeling method 300 includes a step 310 of receiving user input specifying a structure of at least a portion of a data model and a complexity value associated with the specified structure. The data modeling method 300 also includes an outer loop of steps 320-370, and an inner loop of steps 340-360. In step 320, one or more data models are generated. In step 330, complexity scores for the generated data models are determined. In steps 340, 350, and 360, the data modeling tool determines whether to select each of the generated data models for evaluation, and evaluates the accuracy of each of the selected data models. In step 370, the data modeling tool determines whether one or more termination criteria are satisfied. If not, the flow of control returns to step 320. Some embodiments of the data modeling method 300 are described in further detail below.

In step 310, the data modeling tool receives user input specifying a structure of at least a portion of a data model and a complexity value associated with the specified structure. Any suitable technique for specifying the structure of data model (or a portion thereof) may be used, including the techniques described above in Section 1.1.2. The specified structure may include at least one input variable and/or at least one operator. In some cases, the specified structure includes a sequence of two or more operations. Conceptually, during the data model discovery process, the complexity value assigned to the structure by the user may function as a “penalty” reflected in the complexity scores of data models that include the specified structure.

In step 320, the data modeling tool generates one or more data models. Any suitable technique for generating the data models may be used.

In step 330, the data modeling tool determines complexity scores of the generated data models. The complexity score of each data model is based, at least in part, on the complexity of the data model or a portion thereof. Any suitable technique for determining the complexity score of a data model may be used, including the techniques described in Sections 1.0-1.2.

In steps 340, 350, and 360 the data modeling tool determines whether to select the generated data models for evaluation based, at least in part, on their complexity scores. Any suitable technique for selecting data models for evaluation based on their complexity scores may be used including, without limitation, the probabilistic selection techniques described above in Section 2.1. In some embodiments, the data modeling tool selects a data model M for evaluation if the complexity score of the data model M satisfies one or more selection criteria (e.g., if the complexity score of the data model is less than a threshold complexity score or falls within a specified range of complexity scores).

In some embodiments, the data modeling tool discards any data model that includes one or more of the structures specified by the user in step 310. The exclusion of data models that include the user-specified structure(s) may be implemented by assigning the user-specified structure(s) a complexity value so high that the complexity score of any data model that includes any one of the structures would be above a complexity threshold, and by discarding all data models having complexity scores above the complexity threshold. Alternatively, the exclusion of data models that include the user-specified structure(s) may be implemented by identifying and discarding any data models that include one or more of the user-specified structures.

In some embodiments, the data modeling method 300 includes a step of receiving user input specifying one or more constraints on data model properties. In some embodiments, all the data models generated in step 320 satisfy the user-specified constraints on data model properties. In some embodiments, some data models generated in step 320 may not satisfy the user-specified constraints, but any generated data models not satisfying the user-specified constraints on data model properties are discarded in step 340. Conceptually, the provision of constraints on data model properties can force the data modeling tool to evaluate only data models that have the specified properties.

In some embodiments, the data modeling method 300 includes a step of receiving user input specifying one or more data model properties and one or more complexity values associated with the specified properties. Conceptually, during the data model discovery process, the complexity value assigned to a particular data model property by the user may function as a “penalty” reflected in the complexity scores of data models that exhibit the specified property. Some examples of data model properties include statistical properties of a data model's variables, the number of input variables in the data model, the maximum level of nesting of operators in the data model, the number of linearly-separable terms in the data model, etc.

Returning to FIG. 3, in step 370, the data modeling tool may terminate the data model discovery process if any suitable termination criteria are met. Some examples of suitable termination criteria are described above in Section 2.1.

The remainder of this Section describes an example of a data model discovery process carried out by performing an embodiment of the data modeling method 300. The data modeling tool can produce many candidate data models, ranging from structurally simple to complex. The data modeling method 300 does not necessarily prohibit the production of complex models that exhibit undesirable properties (e.g., structural properties), however such models likely have higher complexity scores. As an example, the method 300 can facilitate the use of tunable penalties for various model properties, such as the number of continuous or Boolean variables in each linearly separable term, and/or limits on the nesting depth of a particular category of mathematical operators.

In some embodiments, a user specifies complexity values (e.g., “weights”) which are used to penalize certain properties, such as the number of continuous input variables included in any linearly separable term, the number of Boolean input variables included in any linearly separable term, and/or the maximum depth of nesting of a particular category of mathematical operators in any linearly separable term. In one particular embodiment, the data modeling tool determines a model's complexity based on the tree complexity of the model, plus a penalty applied for each linearly separable term as determined by the number of Boolean and continuous inputs and the nesting depth of certain mathematical operators. The complexity penalties may then affect the progression of the model discovery process by forcing penalized models to have higher complexity scores, such that those models must compete with other complex models.

After models are generated, before they are evaluated, the data modeling tool can determine the complexity scores of the models, and select a subset of models such that the selected models cover the model space without over-sampling any region therein. The data modeling tool can iteratively examine the population of candidate models and select a subset of those models which are allowed to remain as candidate models, discarding the others. The subset can be selected to maximally cover the search space by complexity. In other words, the distribution of complexity values of the selected models can be uniform or substantially uniform (e.g., over a specified range). This complexity balancing process can occur during each iteration of the model discovery process, or less frequently, or asynchronously with respect to iterations of the data model discovery process.

Some embodiments have been described in which the user-specified preference(s) include at least one preference relating to the structure of a data model. In some embodiments, each of the user-specified preference(s) may relate to properties of the data model other than the model's structure.

In some embodiments, the data modeling methods 200 and 300 may be combined in whole or in part, such the model discovery process is guided by user-specified preference information, and such that computational resources are allocated to evaluation of data models based, at least in part, on the interpretability of the data models.

### 3.0 Exemplary User Interfaces for Presenting Visualizations of Data Modeling Information

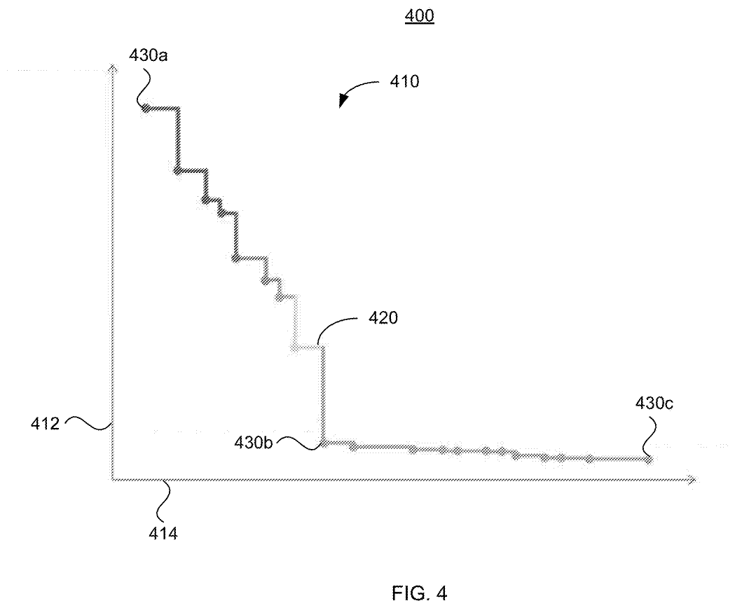

FIG. 4 shows an example of a user interface 400 for presenting information associated with one or more data models, according to some embodiments. In the example of FIG. 4, the user interface 400 includes a visualization 410 of data models discovered during a model discovery process. In the example of FIG. 4, the visualization 410 includes a graph with a horizontal axis 414 representing data model accuracy, a vertical axis 412 representing data model complexity, and points 430 representing discovered data models. The x-coordinate of the point 430 representing a particular data model M corresponds to the data model's accuracy, and the y-coordinate of the point corresponds to the data model's complexity score.

Such a graph may include points 430 representing all data models evaluated during the model discovery process, or a subset of the evaluated data models. In embodiments where the graphed points represent a subset of the evaluated models, the subset may be selected using any suitable technique or criteria (e.g., selection criteria or filtering criteria). For example, the displayed points 430 may represent data models evaluated during a particular time period (e.g., during the previous ten minutes of the model discovery process), which may help the user understand how an ongoing model discovery process is progressing and whether regions of the model space are being under- or over-sampled. As another example, the displayed points may represent data models that satisfy specified criteria (e.g., models with complexity scores less than a specified threshold or within a specified range, models with accuracies less than a threshold or within a specified range, models that include specified structures, models that exhibit specified properties, models that satisfy two or more of the foregoing criteria, etc.).

In some embodiments, the user interface 400 may present a representation of a data model M in response to a user selecting a point 430 representing the data model. For example, the user interface may display a text-based representation of the selected data model. In the example of FIG. 4, when the user selects point 430a, the user interface may display “k₁θ₁+k₂”. As another example, the user interface may synthesize text representing an interpretation of a selected data model and (1) display the synthesized interpretation, and/or (2) convert the synthesized interpretation to speech and present the speech to the user via a speaker device. For example, if the text-based representation of a data model is “c*x”, where c is a binary variable and x is a continuous variable, the user interface may synthesize an interpretation of the data model (e.g., “when <c>, <x> is active”, where <c> is the phenomenon or entity represented by variable c, and <x> is the phenomenon or entity represented by variable x) and display the text-based interpretation or present the corresponding speech.

In the example of FIG. 4, the visualization includes a curve 420 that identifies the points 430 representing data models on the accuracy-interpretability Pareto frontier (or accuracy-complexity Pareto frontier) of evaluated data models. For each data model M_{P} on the accuracy-interpretability Pareto frontier, there is no evaluated data model M that dominates the data model M_{P} in the accuracy dimension and the interpretability dimension (i.e., there is no evaluated data model M_{E} that has both a higher accuracy score and a lower complexity score than the data model M_{P}).

A data modeling tool may use the complexity scores of the evaluated data models to present other visualizations of data models or model discovery processes. In some embodiments, the data modeling tool ranks a set of data models (e.g., models evaluated during a model discovery process) based on the models' complexity scores and presents a list of the data models in rank order (e.g., from lowest complexity to highest complexity). The ability to display a list of data models in rank order by complexity may be a useful feature for a model search engine.

Other techniques for presenting information relating to data models or a model discovery process based on the interpretability of the data models are possible. Such techniques may facilitate comparison of the interpretability of different data models, particularly in cases where the compared data models have disparate structures.

### Further Description of Some Embodiments

According to another aspect of the present disclosure, a data modeling method is provided, including: (a) generating a data model; (b) determining a complexity score of the data model, wherein the complexity score is based, at least in part, on a complexity of the data model or a portion thereof; (c) probabilistically determining whether to select the data model for evaluation, wherein a probability of selecting the data model for evaluation is based, at least in part, on the complexity score of the data model; (d) if the data model is probabilistically selected for evaluation, evaluating an accuracy of the data model for one or more data sets; and repeating steps (a)-(d) for a plurality of data models until one or more specified termination criteria are satisfied.

In some embodiments, the data model includes a number of occurrences of a particular operator, and determining the complexity score of the data model includes adding an operator complexity score to the model complexity score, wherein the operator complexity score depends on a complexity value associated with the particular operator and the number of occurrences of the particular operator in the data model. In some embodiments, the operator complexity score is equal to the product of the complexity value associated with the operator and the number of occurrences of the operator in the data model.

In some embodiments, the data model includes a number of occurrences of a particular input variable, and determining the complexity score of the data model includes adding an input variable complexity score to the model complexity score, wherein the input variable complexity score depends on a complexity value associated with the particular input variable and the number of occurrences of the particular input variable in the data model. In some embodiments, the input variable complexity score is equal to the product of the complexity value associated with the particular input variable and the number of occurrences of the particular input variable in the data model. In some embodiments, the complexity value associated with the particular input variable depends on a data type of the particular input variable. In some embodiments, the complexity value associated with the particular input variable depends on statistical properties of values of the particular input variable in a data set represented by the data model.

In some embodiments, the data model includes one or more operators and one or more input variables, and the method further includes: determining a tree complexity score of the data model based, at least in part, on respective operator complexity values associated with the operators and respective input complexity values associated with the input variables; and adding the tree complexity score of the data model to the model complexity score of the data model. In some embodiments, determining the tree complexity score of the data model includes: for each of the one or more operators, adding a product of a number of occurrences of the respective operator in the data model and the operator complexity value associated with the respective operator to the tree complexity score of the data model; and for each of the one or more input variables, adding a product of a number of occurrences of the respective input variable in the data model and the input complexity value associated with the respective input variable to the tree complexity score of the data model. In some embodiments, the method further includes receiving user input, wherein at least one of the operator complexity values and/or at least one of the input variable complexity values depends on the user input.

In some embodiments, the data model is represented as a sum of two or more terms, and the method further includes: for each of the terms, determining a term complexity score of the respective term; and adding the sum of the term complexity scores of the terms to the model complexity score of the data model.

In some embodiments, the term complexity score of the respective term is based, at least in part, on a level of nesting of operators in the respective term. In some embodiments, the term complexity score of the respective term is further based, at least in part, on a complexity value associated with operator nesting.

In some embodiments, the term complexity score of the respective term is based, at least in part, on a number of input variables in the respective term. In some embodiments, the term complexity score of the respective term is further based, at least in part, on a complexity value associated with the number of input variables. In some embodiments, the term complexity score of the respective term is further based, at least in part, on data types of the respective input variables. In some embodiments, the term complexity score of the respective term is further based, at least in part, on complexity values associated with the respective data types of the input variables. In some embodiments, the term complexity score of the respective term is further based, at least in part, on statistical properties of values of the respective input variables in a data set represented by the data model.

In some embodiments, the term complexity score of the respective term is based, at least in part, on occurrence of a particular structure including at least one input variable and at least one operator in the respective term and on a complexity value associated with the particular structure. In some embodiments, the method further includes receiving user input specifying the particular structure and the complexity value associated with the particular structure. In some embodiments, the user input specifying the particular structure includes a regular expression representing the particular structure and/or a string representing the particular structure in a formal grammar.

In some embodiments, the data model includes at least one output variable, and the method further includes: determining an output variable complexity score of the output variable based, at least in part, on statistical properties of values of the output variable in a data set represented by the data model; and adding the output variable complexity score of the output variable to the model complexity score of the data model.

In some embodiments, the data model is a first data model, determining the complexity score of the first data model includes applying a predictive model to first model data associated with the first data model, wherein the first model data include first attribute data indicative of attributes of the first data model, wherein the predictive model is fitted to second model data associated with a plurality of second data models, and wherein the second model data include attribute data indicative of attributes of the second data models and interpretability data indicative of complexity scores of the respective second data models. In some embodiments, the first attribute data include operator data indicative of one or more operators included in the first data model, structure data indicative of a structure of the first data model, input data indicative of properties of one or more input variables included in the first data model, and/or output data indicative of properties of one or more output variables included in the first data model. In some embodiments, the predictive model includes a regression model or a machine learning model. In some embodiments, the second attribute data include, for each of the second data models, operator data indicative of one or more operators included in the respective second data model, structure data indicative of a structure of the respective second data model, input data indicative of properties of one or more input variables included in the respective second data model, and/or output data indicative of properties of one or more output variables included in the respective second data model.

In some embodiments, the probability of selecting the data model for evaluation is further based, at least in part, on an amount of computational effort already expended for evaluation of data models having the same complexity score as the data model or respective complexity scores within a same particular range as the complexity score of the data model. In some embodiments, the probability of selecting the data model for evaluation is further based, at least in part, on an amount of computational effort budgeted for evaluation of data models having the same complexity score as the data model or respective complexity scores within a same particular range as the complexity score of the data model.

In some embodiments, the data model is a first data model, and the probability of selecting the data model for evaluation is further based, at least in part, on an amount of time elapsed since evaluating a second data model and/or on an amount of computational effort expended since evaluating the second data model. In some embodiments, the second data model has the same complexity score as the first data model or a complexity score within a same particular range as the complexity score of the first data model, and among previously evaluated data models having the same complexity score as the first data model or a complexity score within the same particular range as the complexity score of the first data model, the second data model has the greatest accuracy for the one or more data sets.

In some embodiments, the probability of selecting the data model for evaluation is further based, at least in part, on one or more user-provided heuristics for allocation of computational effort to evaluation of data models based on respective complexity scores thereof.

In some embodiments, the probability of selecting the data model for evaluation is further based, at least in part, on an allocation policy provided by a machine learning model, wherein the allocation policy specifies an allocation of computational effort to evaluation of data models based on respective complexity scores thereof. In some embodiments, the method further includes generating the allocation policy, wherein generating the allocation policy includes applying the machine learning model to status data, wherein the status data include computational effort data indicative of amounts of computational effort already expended for evaluation of data models having complexity scores within respective ranges, and wherein the status data further include evaluation result data indicative of complexity scores and accuracies of data models already evaluated. In some embodiments, the status data are first status data, and the machine learning model is fitted to second status data associated with evaluation of data models for one or more other data sets.

In some embodiments, the method further includes determining a value of an upper limit and a value of a lower limit of a range of complexity scores, wherein the probability of selecting the data model for evaluation is further based, at least in part, on whether the complexity score of the first data model is within the range. In some embodiments, the probability of selecting the data model for evaluation is a first probability if the complexity score of the data model is within the range, and wherein the probability of selecting the data model for evaluation is a second probability if the complexity score of the data model is not within the range. In some embodiments, the first probability is 100%, and the second probability is less than 100%.

In some embodiments, the method further includes increasing the value of the lower limit of the range of complexity scores when a criterion for changing the lower limit is met. In some embodiments, the data model is a first data model, and the criterion for changing the lower limit is met when an amount of time elapsed since evaluating a second data model exceeds a specified threshold. In some embodiments, a complexity score of a second data model matches the lower limit of the range of complexity scores, and among previously evaluated data models having the same complexity score as the second data model, the second data model has the greatest accuracy for the one or more data sets. In some embodiments, the data model is a first data model, and the criterion for changing the lower limit is met when an amount of computational effort expended since evaluating a second data model exceeds a specified threshold. In some embodiments, a complexity score of the second data model matches the lower limit of the range of complexity scores, and among previously evaluated data models having the same complexity score as the second data model, the second data model has the greatest accuracy for the one or more data sets.

In some embodiments, the complexity of the data model depends on a size of the data model, a structure of the data model, one or more operators included in the data model, one or more terms included in the data model, data types of one or more variables included in the data model, and/or statistical properties of one or more variables included in the data model.

According to another aspect of the present disclosure, a data-modeling system is provided, including one or more computers programmed to perform operations including: (a) generating a data model; (b) determining a complexity score of the data model, wherein the complexity score is based, at least in part, on a complexity of the data model or a portion thereof; (c) probabilistically determining whether to select the data model for evaluation, wherein a probability of selecting the data model for evaluation is based, at least in part, on the complexity score of the data model; (d) if the data model is probabilistically selected for evaluation, evaluating an accuracy of the data model for one or more data sets; and repeating steps (a)-(d) for a plurality of data models until one or more specified termination criteria are satisfied.

According to another aspect of the present disclosure, a method for presenting data modeling results is provided, including: determining a plurality of complexity scores of a respective plurality of data models, wherein the complexity score of each data model is based, at least in part, on a complexity of the respective data model or a portion thereof; based on the complexity scores, generating a visualization of information associated with the data models; and presenting, via a user interface of a computer, the visualization of the information associated with the data models. Some embodiments of techniques for determining complexity scores of data models are described above.

In some embodiments, the visualization of information associated with the data models includes a list of user interface items representing the respective data models, and generating the visualization includes: ranking the data models based on the respective complexity scores thereof; and in the list, ordering the user interface items representing the respective data models according to the ranking of the data models.

In some embodiments, the visualization of information associated with the data models includes one or more user interface items representing, respectively, one or more of the data models, and generating the visualization includes: receiving, via the user interface, user input indicating one or more filtering criteria related to complexity scores of data models; for each data model included in the plurality of data models, determining whether the complexity score of the respective data model satisfies the filtering criteria; and if the complexity score of the respective data model satisfies the filtering criteria, including the respective data model in the visualization; and if the complexity score of the respective data model does not satisfy the filtering criteria, excluding the respective data model from the visualization.

In some embodiments, the method further includes determining respective accuracy scores of the data models, wherein the visualization of information associated with the data models includes a graph of user interface items representing at least a subset of the data models, wherein the graph includes a first axis representing data model accuracy and a second axis representing data model complexity, and wherein coordinates of each of the user interface items on the graph correspond to the accuracy score and the complexity score of the data model represented by the respective user interface item. In some embodiments, the graph identifies user interface items representing a set of non-dominated data models in dimensions of data model accuracy and complexity.

In some embodiments, the computer includes a touch screen display, the visualization is presented via the touch screen display, the visualization includes a user interface item representing a first of the data models, and the method further includes: receiving input indicative of user selection of the user interface item via the touch screen display; and in response to the user selection of the user interface item, presenting the first data model via the user interface. In some embodiments, presenting the first data model includes displaying the first data model. In some embodiments, presenting the first data model includes: synthesizing text representing an interpretation of the first data model; and displaying the text representing the interpretation of the first data model. In some embodiments, presenting the first data model includes: synthesizing text representing an interpretation of the first data model; converting the text to speech; and presenting the speech via a speaker of the computer.

According to another aspect of the present disclosure, a system for presenting data modeling results is provided, including one or more computers programmed to perform operations including: determining a plurality of complexity scores of a respective plurality of data models, wherein the complexity score of each data model is based, at least in part, on a complexity of the respective data model or a portion thereof; based on the complexity scores, generating a visualization of information associated with the data models; and presenting, via a user interface of a computer, the visualization of the information associated with the data models.

Data modeling tools, methods, and user interfaces have been described. In some embodiments, data modeling tools, methods, interfaces, and/or portions thereof (e.g., method steps, interface operations, etc.) may be implemented using one or more computers. Such computers can be implemented in digital electronic circuitry, or in computer software, firmware, and/or hardware, including the structures disclosed herein and their structural equivalents, or in combinations of one or more of them. Portions of the subject matter described in this disclosure can be implemented as one or more computer programs, i.e., one or more modules of computer program instructions, encoded on a computer storage medium for execution by, or to control the operation of, data processing apparatus.

Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some embodiments of the methods, steps, and tools described in the present disclosure can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, for example web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some embodiments of the processes and logic flows described in this disclosure can be performed by one or more programmable processors executing one or more computer programs to perform actions by operating on input data and generating output. Some embodiments of the processes and logic flows described herein can be performed by, and some embodiments of the apparatus described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

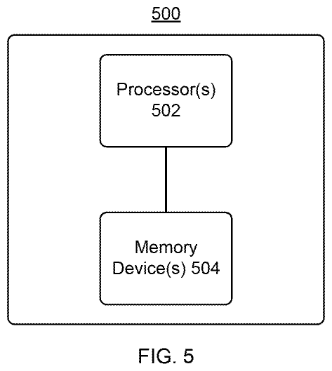

FIG. 5 shows a block diagram of a computer 500. The elements of the computer 500 include one or more processors 502 for performing actions in accordance with instructions and one or more memory devices 504 for storing instructions and data. In some embodiments, one or more programs executing on one or more computers 500 can control the computer(s) to perform the methods described herein and/or to implement the user interfaces described herein. Different versions of the program(s) executed by the computer(s) 500 may be stored, distributed, or installed. Some versions of the software may implement only some embodiments of the methods described herein.

Generally, a computer 500 will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, implementations of the subject matter described in this disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Some embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this disclosure contains many specific implementation details, these should not be construed as limitations on the scope of any inventions or of what may be claimed, but rather as descriptions of features specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations may be described in this disclosure or depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

### Terminology

The phraseology and terminology used herein is for the purpose of description and should not be regarded as limiting.

The terms “approximately” or “substantially”, the phrases “approximately equal to” or “substantially equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

### EQUIVALENTS

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention.

Accordingly, the foregoing description and drawings are by way of example only.

1.-34. (canceled)

35. A system, comprising:
a data processing system comprising memory and one or more processors to:
generate, by a first model input with one or more attributes of a data model, a score corresponding to an amount of computational resources associated with executing the data model, the first model trained using machine learning with input including attributes of one or more predetermined data models;
determine to evaluate the data model based on the score and on computational resources available to the data processing system; and
allocate, by a second model input with the score, one or more of the computational resources available to execute the data model, the second model trained using machine learning and data indicating an amount of computation expended to evaluate one or more predetermined data models.

36. The system of claim 35, the data processing system further configured to:
generate an accuracy metric for the data model, the accuracy metric corresponding to an accuracy of the data model with respect to one or more data sets, the second model obtaining the accuracy metric as input.

37. The system of claim 35, wherein the computation expended corresponds to one or more of a number of data models evaluated, an amount of wall clock time elapsed, an amount of processor time elapsed, an amount of power or energy consumed by the computational resources available, and a number of iterations of execution of one or more of the predetermined data models.

38. The system of claim 35, wherein the computational resources comprise a plurality of processing cores of the processors.

39. The system of claim 38, the data processing system further configured to:
allocate, to the data model, by the second model, a first subset the processing cores, in response to a determination that the score satisfies a first range.

40. The system of claim 39, the data processing system further configured to:
allocate, to the data model, by the second model, a second subset of the processing cores, in response to a determination that the score satisfies a second range.

41. The system of claim 38, wherein the computation expended corresponds to one or more of the processing cores.

42. The system of claim 35, wherein the attributes correspond to a number of constants, terms, or operations associated with the data model.

43. The system of claim 35, the data processing system further configured to:
determine, based on the score, a probability of selecting the data model; and
determine to evaluate the data model, based on the probability.

44. A method, comprising:
generating, by a data processing system comprising one or more processors, via a first model input with one or more attributes of a data model, a score corresponding to an amount of computational resources associated with executing the data model, the first model trained using machine learning with input including attributes of one or more predetermined data models;
determining, by the data processing system, to evaluate the data model, based on the score and on computational resources available to the data processing system; and
allocating, by the data processing system via a second model input with the score, one or more of the computational resources available to execute the data model, the second model trained using machine learning and data indicating an amount of computation expended to evaluate one or more predetermined data models.

45. The method of claim 44, further comprising:
generating, by the data processing system, an accuracy metric for the data model, the accuracy metric corresponding to an accuracy of the data model with respect to one or more data sets, the second model obtaining the accuracy metric as input.

46. The method of claim 44, wherein the computation expended corresponds to one or more of a number of data models evaluated, an amount of wall clock time elapsed, an amount of processor time elapsed, an amount of power or energy consumed by the computational resources available, and a number of iterations of execution of one or more of the predetermined data models.

47. The method of claim 44, wherein the computational resources comprise a plurality of processing cores of the processors.

48. The method of claim 47, further comprising:
allocating, by the data processing system to the data model, by the second model, a first subset the processing cores, in response to a determination that the score satisfies a first range.

49. The method of claim 48, further comprising:
allocating, by the data processing system to the data model, by the second model, a second subset of the processing cores, in response to a determination that the score satisfies a second range.

50. The method of claim 47, wherein the computation expended corresponds to one or more of the processing cores.

51. The method of claim 44, wherein the attributes correspond to a number of constants, terms, or operations associated with the data model.

52. The method of claim 44, further comprising:
determining, by the data processing system based on the score, a probability of selecting the data model; and
determining, by the data processing system, to evaluate the data model, based on the probability.

53. A computer readable medium including one or more instructions stored thereon and executable by a processing system comprising a processor to:
generate, by a first model input with one or more attributes of a data model, a score corresponding to an amount of computational resources associated with executing the data model, the first model trained using machine learning with input including attributes of one or more predetermined data models;
determine to evaluate the data model, based on the score and on computational resources available to the processing system; and
allocate, by a second model input with the score, one or more of the computational resources available to execute the data model, the second model trained using machine learning and data indicating an amount of computation expended to evaluate one or more predetermined data models.

54. The computer readable medium of claim 53, wherein the computer readable medium further includes one or more instructions executable by the processing system to:
determine, based on the score, a probability of selecting the data model; and
determine to evaluate the data model, based on the probability.
